(19) United States
(12) Patent Application Publication
(10) Pub. No.: US 2012/0291359 A1
(43) Pub. Date: Nov. 22, 2012

(54) RECESSABLE ROTARY SLIDING DOOR HANDLE

(75) Inventors: Eric David Hans, Mission Viejo, CA (US); Nicholas Yoshio Sakamoto, Irvine, CA (US)

(73) Assignee: John B, Higman and Valorie J. Higman; Trustees of the Higman Family Trust U/D/T as Amened AND, Brea, CA (US)

(21) Appl. No.: 13/522,478

(22) PCT Filed: Jan. 13, 2011
(86) PCT No.: PCT/US11/21176

§ 371 Date: Jul. 16, 2012

Related U.S. Application Data
(60) Provisional application No. 61/295,966, filed on Jan. 18, 2010.

(51) Int. Cl. E05B 5/02; E05B 65/08; E06B 3/46; E06B 7/28; E05B 1/00

(52) U.S. Cl. 49/449; 49/506; 49/460; 49/404

(57) ABSTRACT

A recessable rotary sliding door handle system provides for comfortable movement of a door or fenestration product with enough durability and strength for everyday use on a large door product. The handle system can include one or two recessable handles with comfortable grips, with balanced weighting to allow the handles to maintain an exposed usable configuration position when swiveled about its axis. In an exposed configuration, the handle is open and accessible for opening and closing a door. In a recessed configuration, the handle is closed to provide a clean appearance and allow the fenestration product to completely pocket within a walled enclosure.

### CROSS-REFERENCE TO RELATED APPLICATIONS

This application claims the benefit of priority to U.S. Provisional Patent Application No. 61/295,966, filed Jan. 18, 2010, and which is incorporated by reference in its entirety herein.

This application incorporates the disclosure of PCT/US2009/047540 filed in English on Jun. 16, 2009, which claims the benefit of priority to U.S. Provisional Application No. 61/073,320, filed Jun. 17, 2008, and which is incorporated by reference in its entirety herein.

### FIELD

The present application discloses various embodiments of door handle systems, such as for a sliding door system.

### SUMMARY

Several embodiments of the present invention relate to recessable door handles and, more specifically, to a recessable door handle assembly including one or more rotatably actuatable door handles that can be used on one or both sides of a sliding door panel. In one embodiment, the handle system can be mounted on the inside or the outside of a door. In one embodiment, the handle system can extend between the inside and the outside of a door, with one or more handles. In one embodiment, the handle can be configured to withstand lateral forces sufficient to controllably actuate or slide a door. In one embodiment, the handle can be mounted on the edge of a door to pull or push a door in or out from the edge of the door.

Although some embodiments will be described in the context of use on a sliding door system, some embodiments of the handle can be used on any type of door or panel for moving an object. Various sliding doors and door systems have long been a desirable option for providing access to residences, businesses and other structures as they can provide a large opening without requiring a large swing area, as might be required with a swinging door of the same size. Moreover, in some door systems, two or more sliding door panels have been arranged, typically sliding on parallel tracks, to form a “multislide” door system that can span a relatively large opening. The individual door panels of a multislide door system can include relatively large transparent or translucent windowpanes to provide access to a panoramic view or a large amount or light even when the door system is closed. Substantially all of the door panels of certain multislide systems can be retracted into a pocket in an adjacent wall, such that when the door system is open, an indoor/outdoor building space is created.

Handles on doors provide door users with a way to grasp and manipulate the door, and to move and in some embodiments, unlock a door. In some embodiments of the present invention, handles remain visible or accessible. In some embodiments, handles can be moved between an exposed and an obscured configuration. In one embodiment, an exposed handle can be grasped and more-readily seen than an obscured configuration. In one embodiment, an obscured configuration can be a recessed configuration in which the handle is moved out of the way. In one embodiment, the recessed configuration allows a sliding door to slide by other panels or doors or walls or pockets with less required clearance than an exposed or extended handle. Some embodiments of door systems include relatively large lever handles on each door panel to allow a user to move the door. In some embodiments, a handle can be used to raise and lower the panel slightly (such as raised for sliding, lowered for sealing).

In some embodiments, exposed handles may prevent panel interlockers from sealing, thereby allowing air infiltration. In certain instances, embodiments of doors may use large handles to leverage the heavy panels between open and closed position, or for moving or stacking flush to each other in various positions. In some instance, large handles may prevent the panels from going all the way into the pocket.

In several embodiments, the invention comprises a recessable rotary door handle system configured for lateral movement of one or more sliding doors. In one embodiment, the handle system comprises a first rotatable handle rotatably engaged to a first faceplate, and a second rotatable handle rotatably engaged to a second faceplate. The first faceplate is configured for engagement with the second faceplate through a door panel, the door panel comprising an interior side, an exterior side and an edge between the exterior side and the interior side. In one embodiment, the first faceplate is configured to be disposed on the interior side of the door panel and the second faceplate is configured to be disposed on the exterior side of the door panel. In one embodiment, the first handle is rotatably actuatable between a recessed configuration and an exposed configuration and the second handle is rotatably actuatable between the recessed configuration and the exposed configuration. In one embodiment, the recessable rotary door handle system is further comprises a door panel. In one embodiment, the door panel further comprising a lock system.

In some embodiments, a recessable rotary door handle system configured for lateral movement of one or more sliding doors, and includes a first rotatable handle rotatably engaged to a first faceplate and a second rotatable handle rotatably engaged to a second faceplate. In one embodiment, the first faceplate is configured for engagement with the second faceplate through a door panel, the door panel comprising an interior side, an exterior side and an edge between the exterior side and the interior side. In one embodiment, the first faceplate is configured to be disposed on the interior side of the door panel. In one embodiment, the second faceplate is configured to be disposed on the exterior side of the door panel. In one embodiment, the first handle is rotatably actuatable between a recessed configuration and an exposed configuration. In one embodiment, the second handle is rotatably actuatable between the recessed configuration and the exposed configuration.

In one embodiment, the recessable rotary door handle system also includes a first door panel. In one embodiment, the recessable rotary door handle system also includes a second door panel, wherein at least one of the first rotatable handle and the second rotatable handle is configured to slide the first door panel in the exposed configuration and is configured for sliding the first door panel along the second door panel when the at least one of the first rotatable handle and the second rotatable handle is in the recessed configuration. In one embodiment, the recessable rotary door handle system also includes a lock system. In one embodiment, the lock system includes a lock hook.

In one embodiment, the recessable rotary door handle system has the first rotatable handle weighted to allow it to maintain the exposed configuration when swiveled about its axis by an angle with respect to the first face plate in a first direction. In one embodiment, the recessable rotary door handle system has the first rotatable handle weighted to allow it to maintain the recessed configuration when swiveled about its axis by an angle with respect to the first face plate in a second direction. In one embodiment, the recessable rotary door handle system has a first rotatable handle configured to support a lateral force to open or close one or more door panels. In one embodiment, the recessable rotary door handle system has a first rotatable handle configured to support a lateral force of at least 1,000 pounds to open or close one or more door panels. In one embodiment, the recessable rotary door handle system has a first rotatable handle configured to support a lateral force of at least 100 pounds to open or close one or more door panels. In one embodiment, the first rotatable handle comprises a finger grip for actuating the first rotatable handle between the recessed configuration to the exposed configuration.

In some embodiments, a recessable rotary door handle system configured for lateral movement of a sliding door includes a rotatable handle rotatably engaged to a faceplate, wherein the faceplate is configured for engagement with at least one of an interior side and an exterior side of a sliding door panel and the handle is rotatably actuatable between a recessed configuration and an exposed configuration. In one embodiment, an axis of rotation of the rotatable handle is parallel to a movement direction of the sliding door panel. In one embodiment, the faceplate is configured to be disposed on the interior side of the door panel. In one embodiment, the second faceplate is configured to be disposed on the exterior side of the door panel. In one embodiment, the door panel further comprises a lock system.

In some embodiments, a method of operating a sliding door includes rotating a first rotatable handle from a recessed configuration to an exposed configuration, the first rotatable handle rotatably engaged to a first sliding door panel, the door panel comprising an interior side, an exterior side and a sliding movement direction and applying a lateral force to the first rotatable handle in the exposed configuration to move the first sliding door along the sliding movement direction. In one embodiment, an axis of rotation of the rotatable handle is parallel to the movement direction of the sliding door. In one embodiment, the method also includes rotating a second rotatable handle from a recessed configuration to an exposed configuration, the second rotatable handle rotatably engaged to the first sliding door panel on a side opposite the first rotatable handle, and applying a lateral force to the second rotatable handle in the exposed configuration to move the first sliding door along the sliding movement direction.

In one embodiment, the method also includes rotating a second rotatable handle from a recessed configuration to an exposed configuration, the second rotatable handle rotatably engaged to a second sliding door panel, the second sliding door panel comprising an interior side, an exterior side and a sliding movement direction parallel to the sliding movement direction of the first sliding door panel and applying a lateral force to the second rotatable handle in the exposed configuration to move the second sliding door along the sliding movement direction.

The details of various embodiments are set forth in the accompanying drawings and the description herein. Other features and advantages will be apparent from the description and drawings, and from the claims.

### BRIEF DESCRIPTION OF THE DRAWINGS

These and other aspects of embodiments of the present invention will now be described in detail with reference to the following drawings.

FIGS. 1A-1C are front and isometric views of a recessed configuration of a door handle system according to an embodiment of the present invention;

FIGS. 2A-2C are front and isometric views of an exposed configuration of a door handle system according to FIGS. 1A-1C;

FIG. 3 is an isometric view of a recessed configuration of an inside door handle system with wood paneling according to an embodiment of the present invention;

FIG. 4 is an isometric view of a exposed configuration of an inside door handle system with wood paneling according to FIG. 3;

FIG. 5 is an isometric view of a recessed configuration of an outdoor door handle system according to an embodiment of the present invention;

FIG. 6 is an isometric view of an exposed configuration of an outside door handle system according to FIG. 5;

FIG. 7 is an isometric view of a recessed configuration of an inside door handle system according to an embodiment of the present invention;

FIG. 8 is an isometric view of an exposed configuration of an inside door handle system according to FIG. 7;

FIGS. 9A-9C are front views of an inside lock system and a door handle system according to an embodiment of the present invention;

FIG. 10A is an isometric view of a lock system in an unlocked configuration according to an embodiment of the present invention;

FIG. 10B is an isometric view of a lock system in an locked configuration according to FIG. 10A;

FIG. 11A is an isometric view of a lock system in an unlocked configuration according to an embodiment of the present invention;

FIG. 11B is an isometric view of a lock system in an locked configuration according to FIG. 11A;

FIG. 12 is an side view of a lock system and a handle system according to an embodiment of the present invention;

FIGS. 13A-13B are isometric views of an inside lock system and a door handle according to an embodiment of the present invention;

FIG. 14 is an isometric view of one optional step in actuating a door handle system according to an embodiment of the present invention;

FIG. 15 is an isometric view of one optional step in actuating a door handle system according to an embodiment of the present invention;

FIG. 16 is an isometric view of a closed door handle configuration according to an embodiment of the present invention;

FIG. 17 is an isometric view of one optional step in actuating a door handle system according to an embodiment of the present invention;

FIG. 18 is an isometric view of one optional step in actuating a door handle system according to an embodiment of the present invention;

FIG. 19 is an isometric view of an open door handle configuration according to an embodiment of the present invention;

FIG. 20 is a schematic isometric view of a handle according to an embodiment of the present invention;

FIG. 21 is a schematic top view of the handle according to FIG. 20;

FIG. 22 is a schematic back view of the handle according to FIG. 20;

FIG. 23 is a schematic right side view of the handle according to FIG. 20;

FIG. 24 is a schematic isometric view of an outside handle plate according to an embodiment of the present invention;

FIG. 25 is a schematic cross-sectional top view of the outside handle plate according to FIG. 24;

FIGS. 26A-26C are schematic back, front and side views of the outside handle plate according to FIG. 24;

FIG. 27 is a schematic isometric view of an inside handle plate according to an embodiment of the present invention;

FIG. 28 is a schematic cross-sectional top view of the inside handle plate according to FIG. 27;

FIGS. 29A-29C are schematic back, front and side views of the inside handle plate according to FIG. 27;

FIG. 30 is a schematic left side view of a door handle system with one handle in an exposed configuration according to an embodiment of the present invention;

FIG. 31 is a schematic right side view of the door handle system according to FIG. 30;

FIG. 32 is a schematic inside or a front view of the door handle system according to FIG. 30;

FIG. 33 is a schematic outside or a back view of the door handle system according to FIG. 30;

FIG. 34 is a schematic partially sectional top view of the door handle system according to FIG. 30;

FIG. 35 is a schematic partially sectional bottom view of the door handle system according to FIG. 30;

FIG. 36 is a schematic isometric view of the door handle system according to FIG. 30;

FIG. 37 is a schematic left side view of the door handle system with the door panel removed according to FIG. 30;

FIG. 38 is a schematic right side view of the door handle system with the door panel removed according to FIG. 30;

FIG. 39 is a schematic top view of the door handle system with the door panel removed according to FIG. 30;

FIG. 40 is a schematic bottom view of the door handle system with the door panel removed according to FIG. 30;

FIG. 41 is a schematic isometric view of the door handle system with the door panel removed according to FIG. 30;

FIG. 42 is a schematic left side view of the door handle system with the door panel, inside handle plate and outside handle plate removed according to FIG. 30;

FIG. 43 is a schematic isometric view of the door handle system with the door panel, inside handle plate and outside handle plate removed according to FIG. 30.

Like reference symbols in the various drawings indicate like elements. Throughout the figures, the same reference numerals and characters, unless otherwise stated, are used to denote like features, elements, components or portions of the illustrated embodiments. Moreover, while embodiments of the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

In one embodiment, a handle system 200 is configured to provide a door user with an easy use handle for comfortable movement of a fenestration product with enough durability and strength for everyday use on a large door product. In one embodiment, the handle system 200 can be used with a sliding door product, including one, two, three, four, or five or more sliding door panels. In several embodiments, the handles described herein are particularly suitable for the sliding doors described in PCT/US2009/047540, filed on Jun. 16, 2009, which is incorporated by reference in its entirety herein. In one embodiment, the handle comprises at least one comfortable grip and with a certain weighting to allow it to maintain an open position when swiveled about its axis. In one embodiment, a simple push at the top of the handle and the weighting will force the handle to rotate and recess within the door stile. In one embodiment, the weighting also keeps the handle closed to provide a clean appearance and allow the fenestration product to completely pocket within a walled enclosure.

In various embodiments, the handle system 200 can be manufactured from stainless steel for strength but can be completed with multiple finishes to accommodate specific needs of a customer whether for harsh weather conditions or more aesthetically pleasing to their tastes.

In one embodiment, the handle system 200 comprises a handle that is offset in its faceplate so that it can have a second handle that is similar to, or a mirror image of, or identical to the handle unit on the opposite side of the door panel 10 while maintaining the size and strength of the door system 11 with respect to the door panel 10. In one embodiment, bumpers and/or interior stops are provided to reduce noise while opening and closing the handle. In one embodiment, the shoulders on the back of the faceplate provide the support for lateral forces that exist when opening and closing a fenestration product, unlike other rotating handles designed as edge pulls and not for everyday constant use.

In various embodiments, one or more door handle systems 200 may be used on one or more door panels 10. In various embodiments, any number of embodiments of one or more door panels 10 can be used to form a door panel system 11. In various embodiments, additional door panels can be denoted with a prime symbol, such as a first door panel 10, a second door panel 10′, a third door panel 10″, etc. In one embodiment, the door panel 10 is configured to open and close between an interior 120 and an exterior 122. In one embodiment, the interior 120 is the inside of a building, house, room, or structure. In one embodiment, the exterior 122 is the outside of a building, house, room, or structure. In various embodiments, although the term interior 120 or exterior 122 is used, the names are being used in reference to a side of embodiments of the door panel 10 and can simply refer to a side of a wall or side of the door panel 10 whether one side is in or out of a structure or wall. In various embodiments the interior 120 and/or exterior 122 can be any combination of inside, outside, both inside or both outside of a structure, wall, etc. In various embodiments, the door panel 10 can comprise vertical stiles 12, 14 and horizontal rails 16, 18. In one embodiment, the door panel 10 comprises an edge 20 along a stile 12, 14. The stiles and rails can comprise a rigid material such as a wood, metal, plastic or polymer, composite, or other suitable material construction. In some embodiments, the stiles 12, 14 and the rails 16, 18 comprise a hardwood. In some embodiments, the stiles 12, 14 and the rails 16, 18 comprise aluminum. In some embodiments, the stiles 12, 14 and the rails 16, 18 comprise a wood reinforced with at least a metallic strip. Where the stiles 12, 14 and the rails 16, 18 are comprised of a metal, in some embodiments, they can be formed by extrusion. In various embodiments, any combination of materials can be used.

In one embodiment, the door panel system 200 comprises a handle 210 rotatably attachable to a faceplate 220, the faceplate attachable to a door panel 10. In one embodiment, the handle 210 and the faceplate 220 are positioned on the interior 120 of the door panel 10. In one embodiment, the handle 210 and the faceplate 220 are positioned on the exterior 122 of the door panel 10. In one embodiment, the door panel system 200 comprises a first handle 210, a first faceplate 220, and a second faceplate 240, with the first faceplate 220 positionable on a first side of a door panel 10 and the second faceplate 240 positionable on a second side of the door panel 10. In various embodiments, the first side of a door panel 10 may be on the interior 120 or the exterior 122. In various embodiments, the second side of a door panel 10 may be on the interior 120 or the exterior 122, opposite the first side of the door panel 10. In one embodiment, the second faceplate 240 is attachable to the first faceplate 220 through the door panel 10 in any number of connection means, including but not limited to being formed as one piece, being attached with one or more screws, nuts, locks, interfaces, snap fits, adhesives, bonds, magnets, or other ways of permanently or reversibly attachable mechanisms. In one embodiment, the second faceplate 240 is rotatably attachable to a second handle 230.

In one embodiment, a handle 210, 230 can have a recessed configuration 250 and an exposed configuration 260. In various embodiments, the recessed configuration 250 can be a closed, retracted or hidden configuration, wherein the handle 210, 230 is positioned with respect to the faceplate 220, 240 in such a manner that it provides more clearance for the door panel 10 to move with respect to other objects, or to simply hide the handle 210, 230 from view. In various embodiments, the exposed configuration 260 can be an open or extended configuration, wherein the handle 210, 230 is positioned with respect to the faceplate 220, 240 in such a manner that it can be grasped or manipulated.

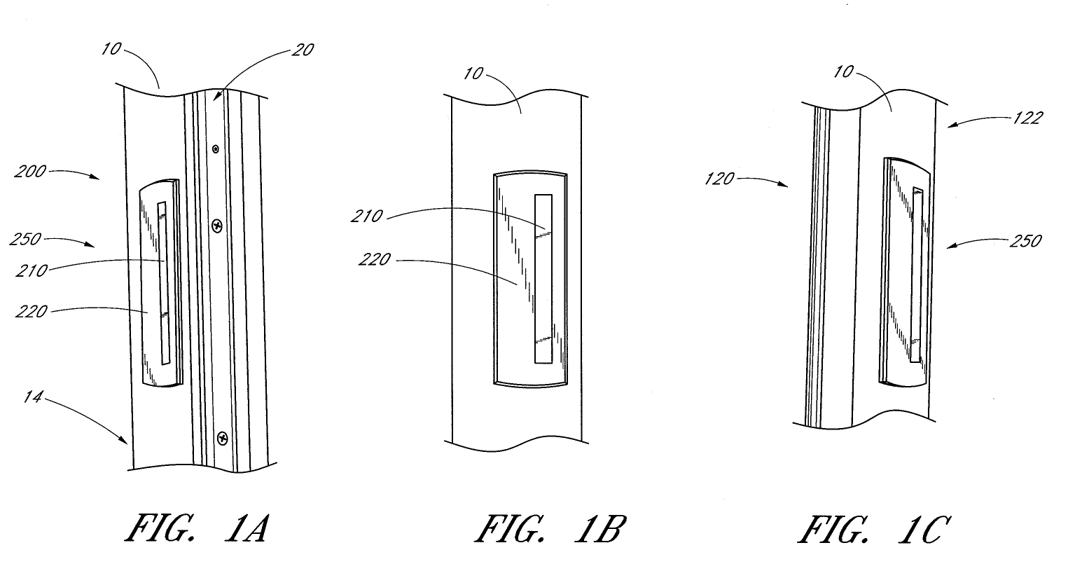

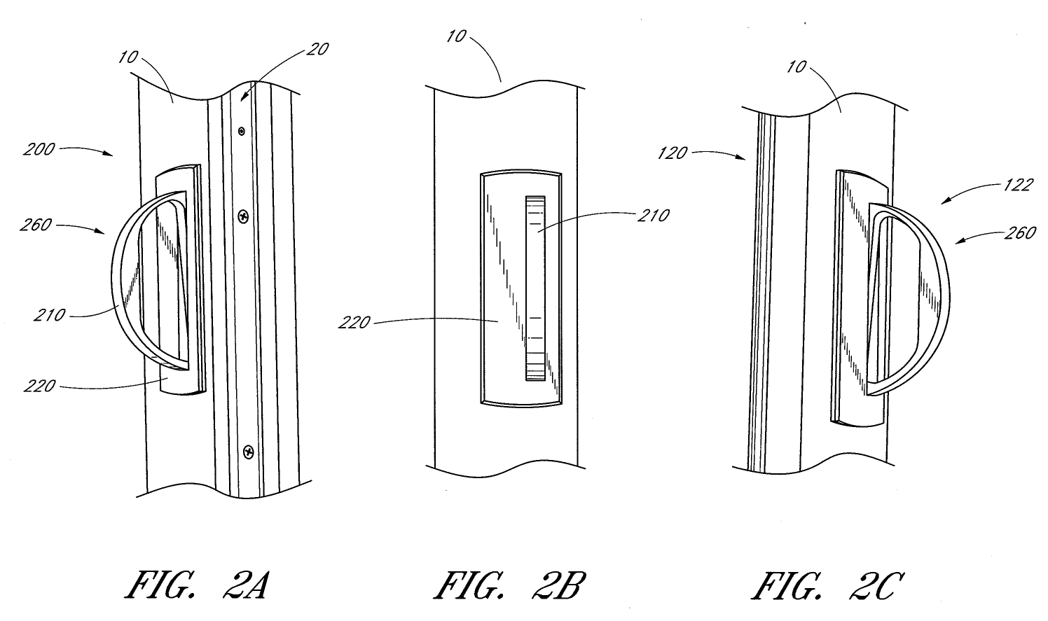

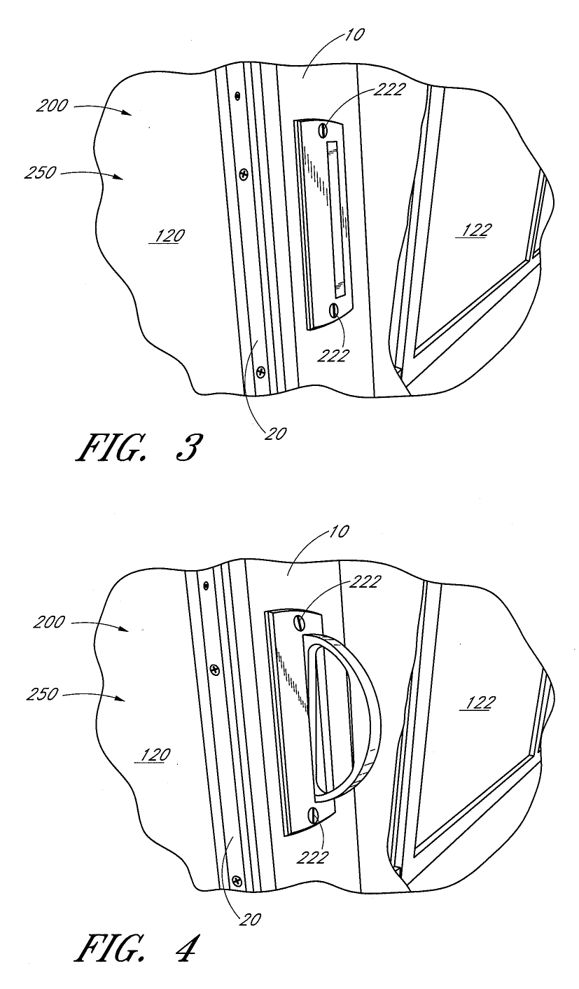

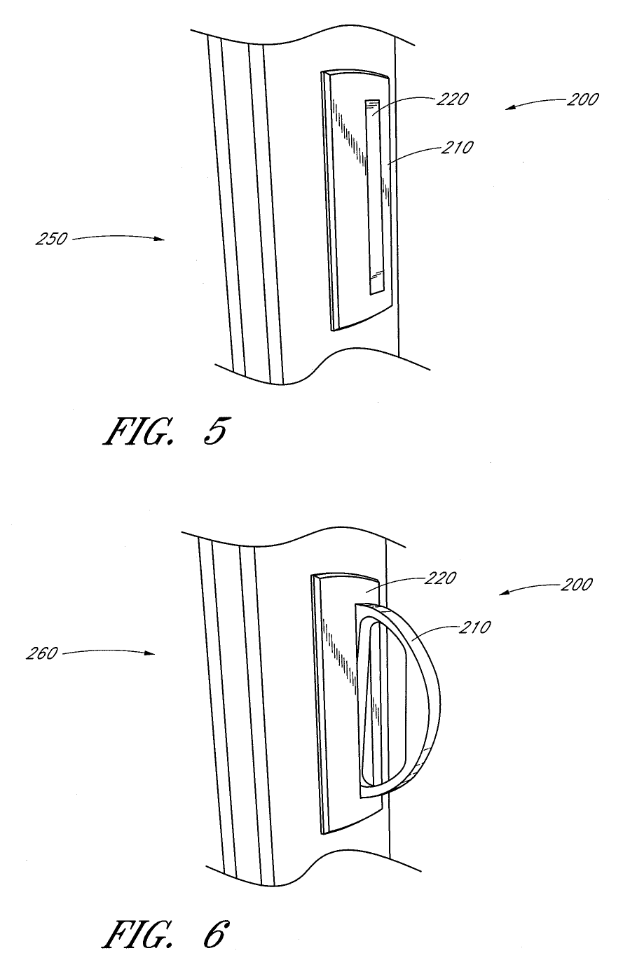

FIGS. 1A-1C illustrate a recessed configuration 250 of a door handle system 200 according to an embodiment of the present invention. FIGS. 2A-2C illustrate an exposed configuration 260 of a door handle system 200 according to FIGS. 1A-1C. As illustrated in FIGS. 1A-2C, the handle 210 and faceplate 220 are mounted on the exterior 122 of a door panel 10. In one embodiment, the exterior faceplate 220 has mounting hardware obscured for security and aesthetic reasons, such that a user from the exterior 122 can not easily access or remove any mounting hardware, such as bolts or screws, from the exterior faceplate 220.

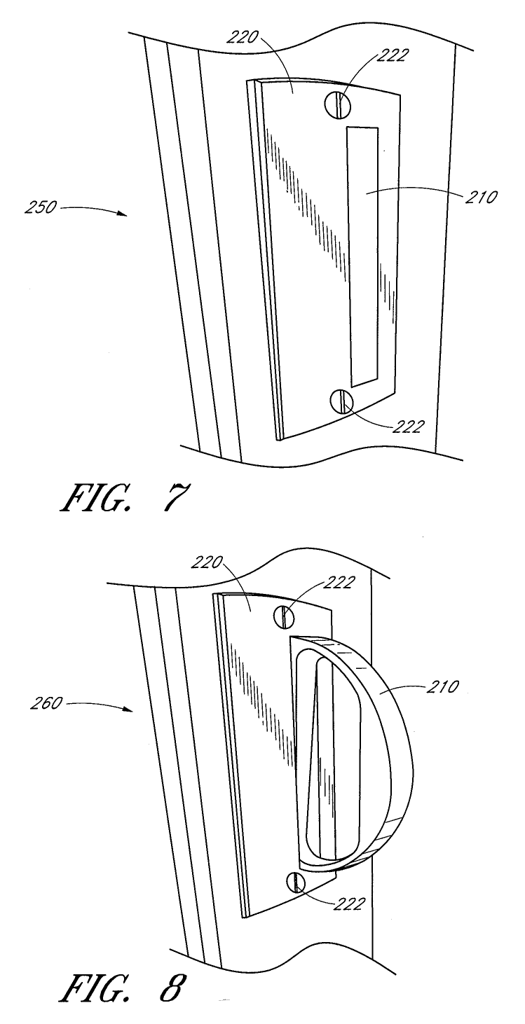

In one embodiment, a door panel 10 can include an extrusion and various finishes or materials. In one embodiment, a door panel 10 can comprise wood paneling. FIG. 3 illustrates a recessed configuration 250 of an inside door handle system 200 with wood paneling according to an embodiment of the present invention. FIG. 4 illustrates an exposed configuration 260 of an inside door handle system 200. In one embodiment, an inside or interior faceplate 220 can have exposed attachment hardware, such as screw or bolt heads exposed for secure access for installation, removal or maintenance to the door handle system 200.

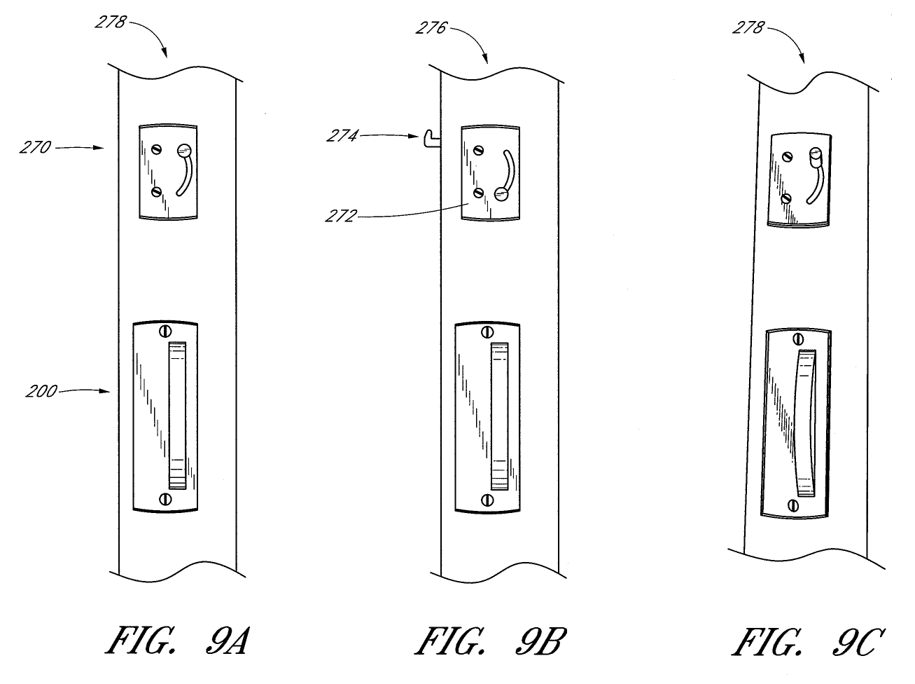

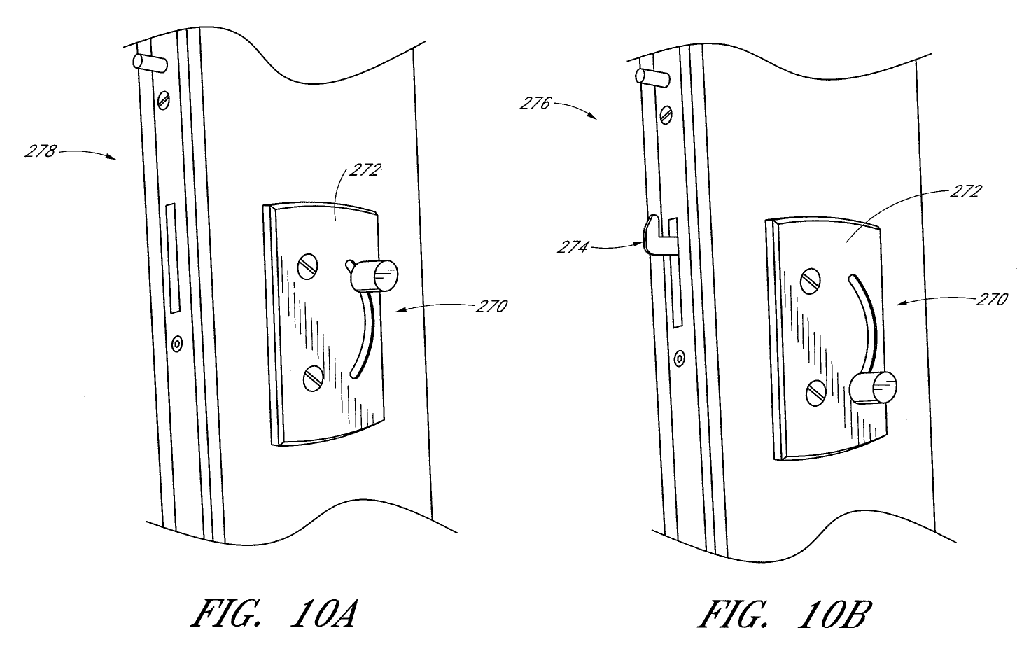

FIG. 5 illustrates a recessed configuration 250 of an outdoor door handle system 200 according to an embodiment of the present invention. FIG. 6 illustrates an exposed configuration 260 of an outside door handle system 200 according to FIG. 5. FIG. 7 illustrates a recessed configuration 250 of another embodiment of an inside door handle system 200. FIG. 8 illustrates an exposed configuration 260 of an inside door handle system 200 according to FIG. 7.

In one embodiment, the door panel 10 can also include a lock system 270 configurable between a locked position 276 and an unlocked position 278. In one embodiment, the lock system 270 can comprise a lock latch 272 and a lock hook 274. In one embodiment, the lock system 270 disposed in one of the stiles 12, 14 or the rails 16, 18. The lock system 270 can be used to selectively secure the door panel 10 in a fixed position with respect to another door panel 10 in a door panel system 11, or to secure the door panel 10 to a door frame 1 (not illustrated).

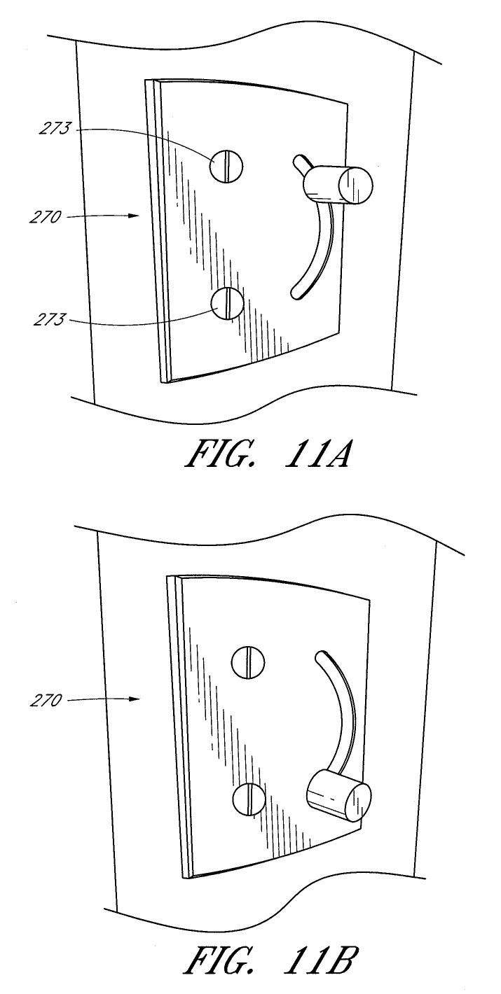

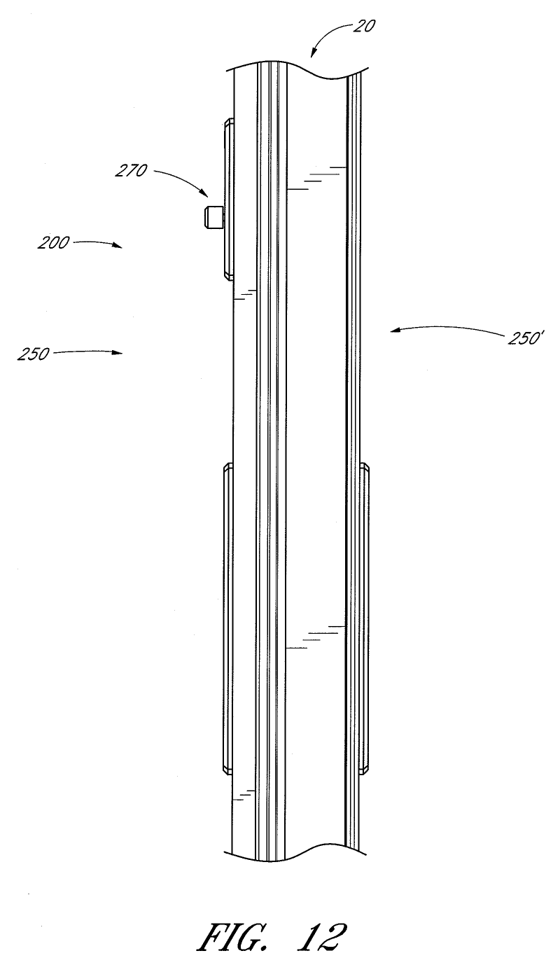

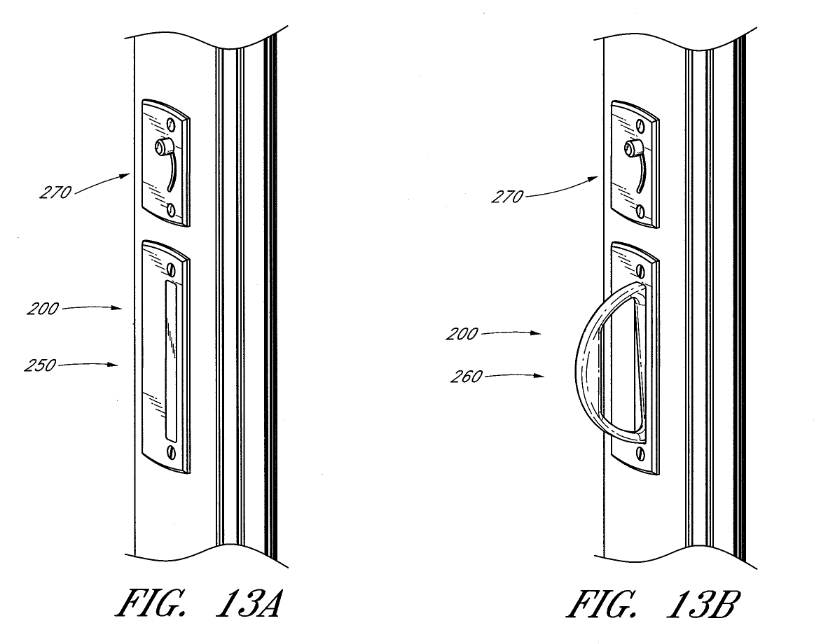

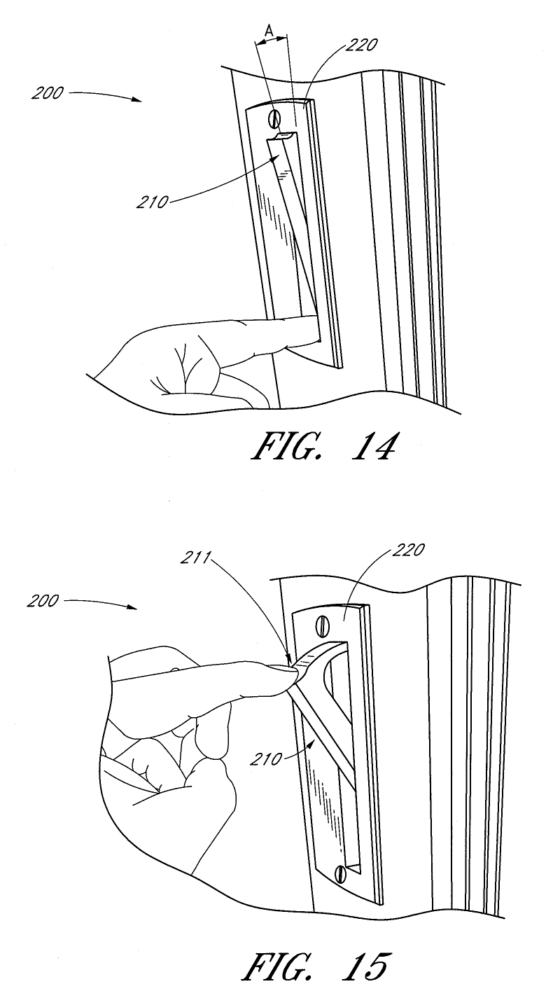

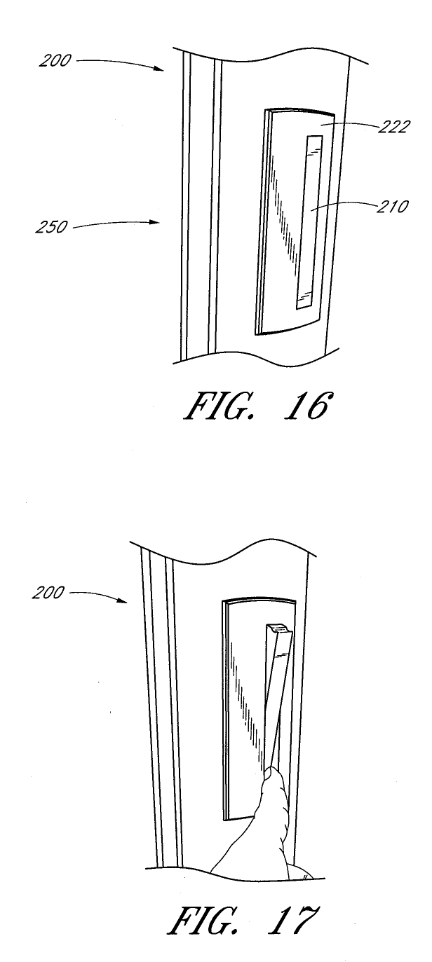

FIGS. 9A-9C illustrate an inside lock system 270 and a door handle system 200 according to an embodiment of the present invention. FIG. 10A illustrates a lock system 270 in an unlocked configuration 278 according to an embodiment of the present invention. FIG. 10B illustrates a lock system 270 in a locked configuration 276 according to FIG. 10A. In one embodiment, the lock latch 272 can have one or more attachment mechanisms 273. In one embodiment, an attachment mechanism can be a screw or other device for attaching the lock system 270 to a door panel 10. FIG. 11A illustrates a lock system 270 in an unlocked configuration 278 according to an embodiment of the present invention. FIG. 11B illustrates a lock system 270 in a locked configuration 276 according to FIG. 11A. FIG. 12 illustrates a lock system 270 and a handle system 200 with two handles 210 in recessed configuration 250, 250′, according to an embodiment of the present invention. FIGS. 13A-13B illustrate an inside lock system 270 and a door handle 200 according to an embodiment of the present invention.

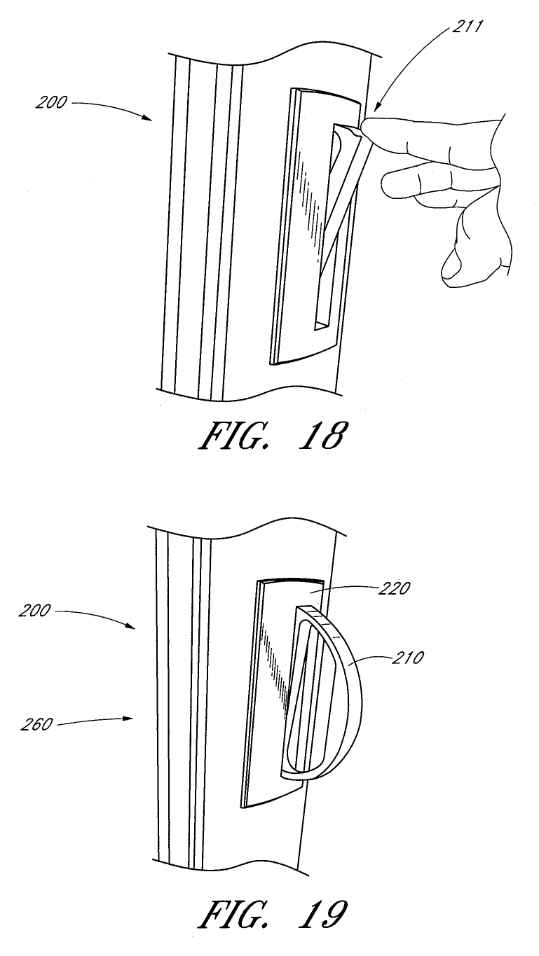

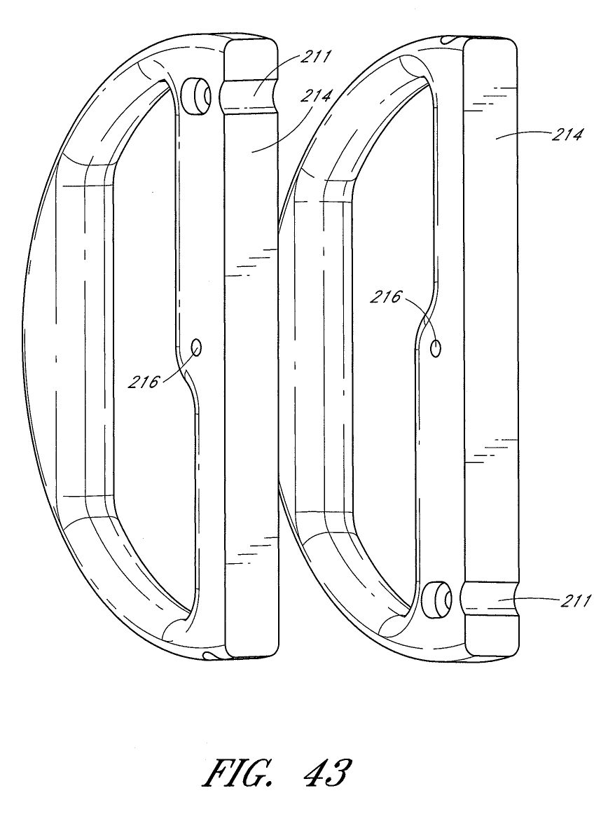

In one embodiment, a door handle system 200 can be actuated in a number of steps. FIG. 14 illustrates one optional step in actuating a door handle system 200 according to an embodiment of the present invention. In one embodiment, the bottom of a handle 210 can be pushed inward toward the door panel 10. This rotates the handle 210 such that the top of the handle 210 extends outwards away from the door panel 10 and from the faceplate 220. In one embodiment, the handle 210 is weighted in such a way that once the handle 210 is displaced by more than an angle A, the center of gravity of the handle 210 causes the handle 210 to automatically continue rotating between the recessed configuration 250 and the exposed configuration 260 with the assistance of gravity. In one embodiment illustrated at FIG. 42, the handles 210, 230 reflect non-symmetries that effect the weighting. In one embodiment, the handle 210 is balanced on the axis of rotation with respect to the faceplate 220. Upon removal of a finger or displacement force, with a relative angle between the handle 210 and the faceplate 220 of less than angle A, the handle 210 is weighted to rotate to a recessed configuration 250. At greater angles than angle A, the handle 210 is weighted to rotate to an exposed configuration 260. In various embodiments, the angle A can be 5 degrees, 10 degrees, 15 degrees, 20, degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, or 125 degrees or more.

In one embodiment, the handle 210 also comprises a finger grip 211. FIG. 15 illustrates one optional step in actuating a door handle system 200 according to an embodiment of the present invention. In one embodiment, the bottom of a handle 210 can be pushed inward toward the door panel 10. This rotates the handle 210 such that the top of the handle 210 extends outwards away from the door panel 10 and from the faceplate 220, exposing a finger grip 211. A door handle user can place a finger or other object on the finger grip 211 to hold it in position for further manipulation or rotation.

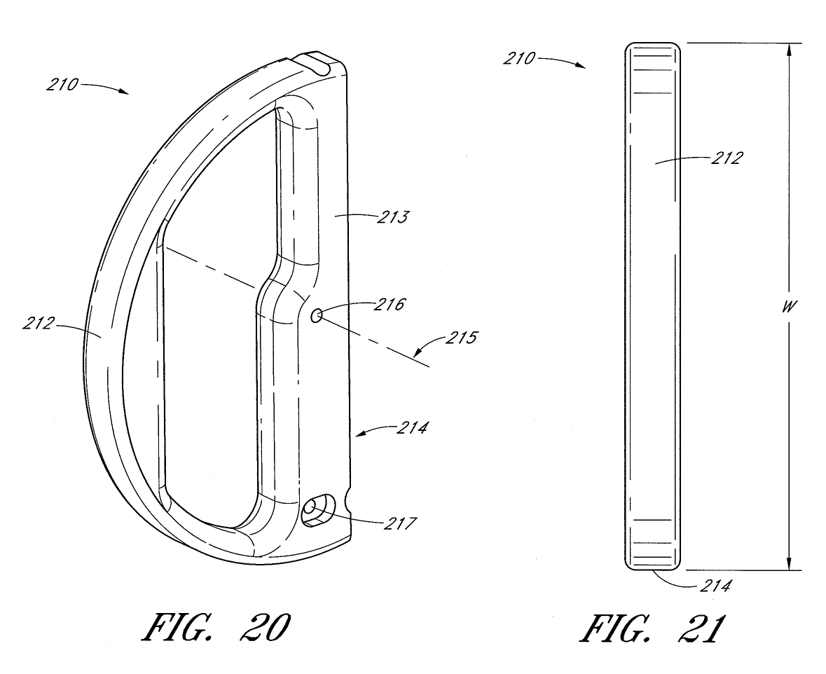

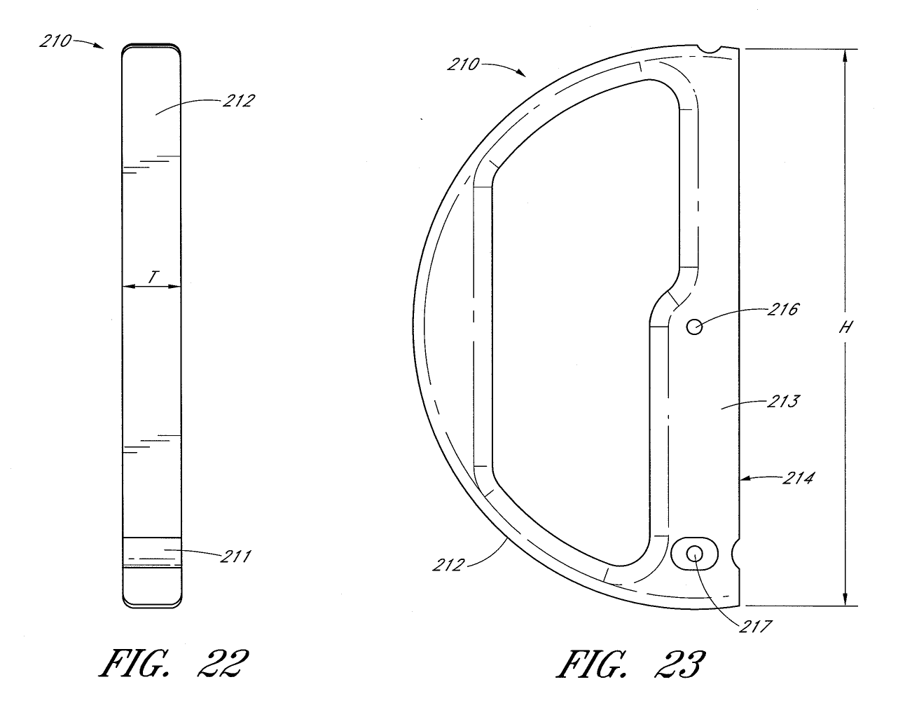

FIGS. 16-19 illustrate steps in actuating a door handle system 200 between a recessed configuration 250 and an exposed configuration 260. FIG. 18 is an optional step with the use of a finger hold 211. The steps can be reversed, optionally excluding the use of a finger hold 211, to move between an exposed configuration 260 and a recessed configuration 250.

In various embodiments, the components of a door handle system 200 can comprise a rigid material such as a wood, metal, plastic or polymer, composite, or other suitable material construction. In some embodiments, the door handle system 200 comprises stainless steel. In some embodiments, the door handle system 200 comprises corrosion resistant materials. In some embodiments, the door handle system 200 comprises 304 stainless steel. In some embodiments, the door handle system 200 comprises bronze. In some embodiments, the door handle system 200 comprises brass. In some embodiments, the door handle system 200 comprises aluminum. Where the door handle system 200 components are comprised of a metal, in some embodiments, they can be formed by extrusion, casting, machining, or other techniques. In various embodiments, the door handle system 200 comprises a coating, finish and/or surface treatment. In various embodiments, the door handle system components can be brushed, oiled, anodized, painted; powder coated, kynar wet painted, gold plated, brass finished, can be finished in a satin, chrome, or other manner. In various embodiments, any combination of materials can be used. In some embodiments, the door handle system 200 comprises a hardwood. In some embodiments, the door handle system 200 comprises a wood reinforced with at a metallic strip.

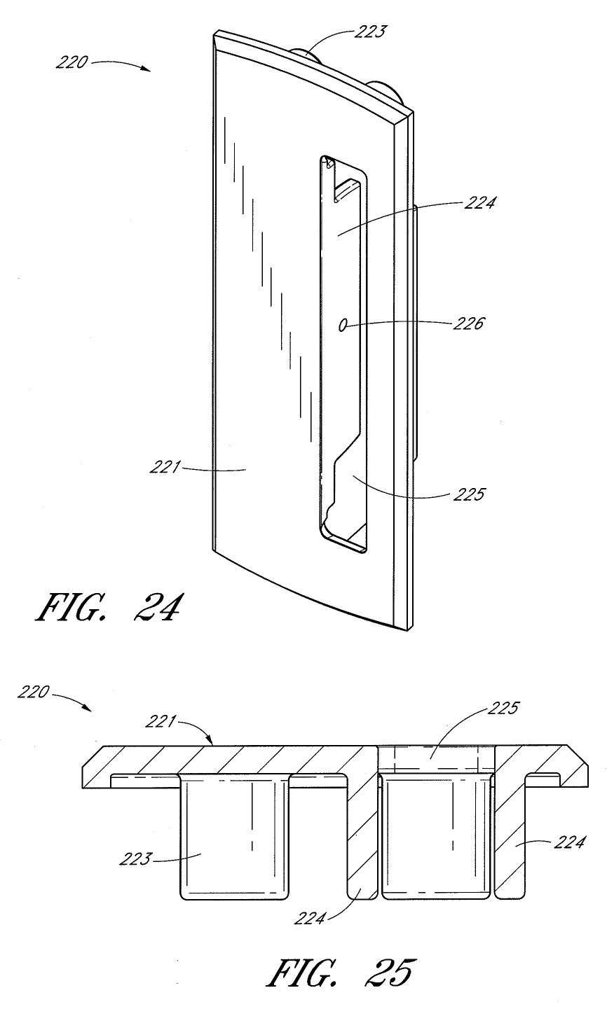

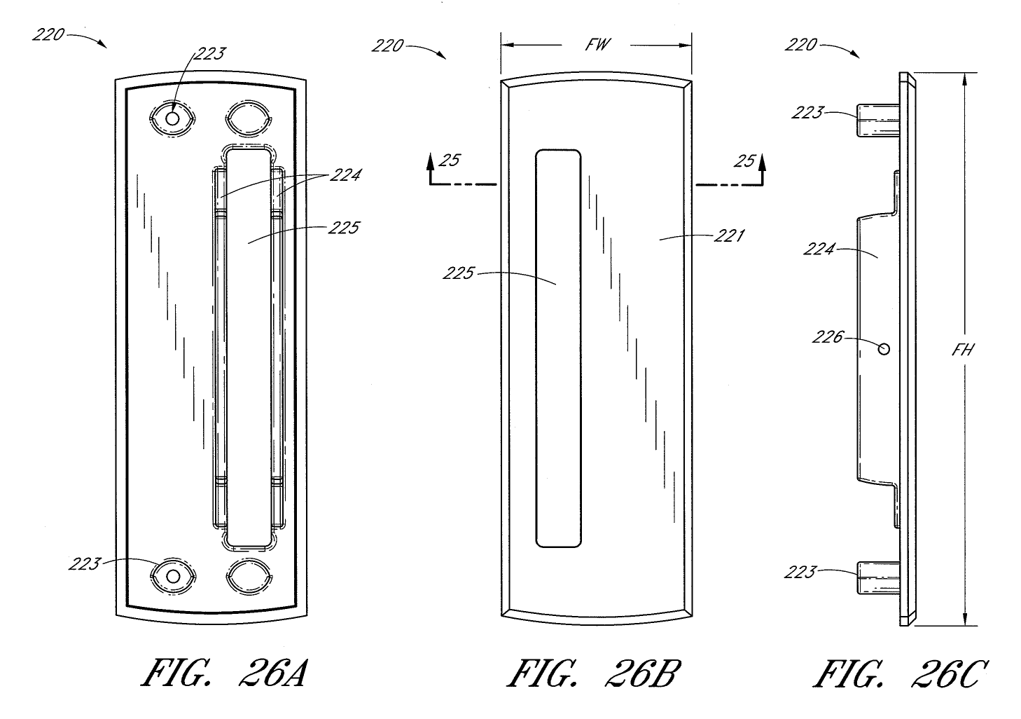

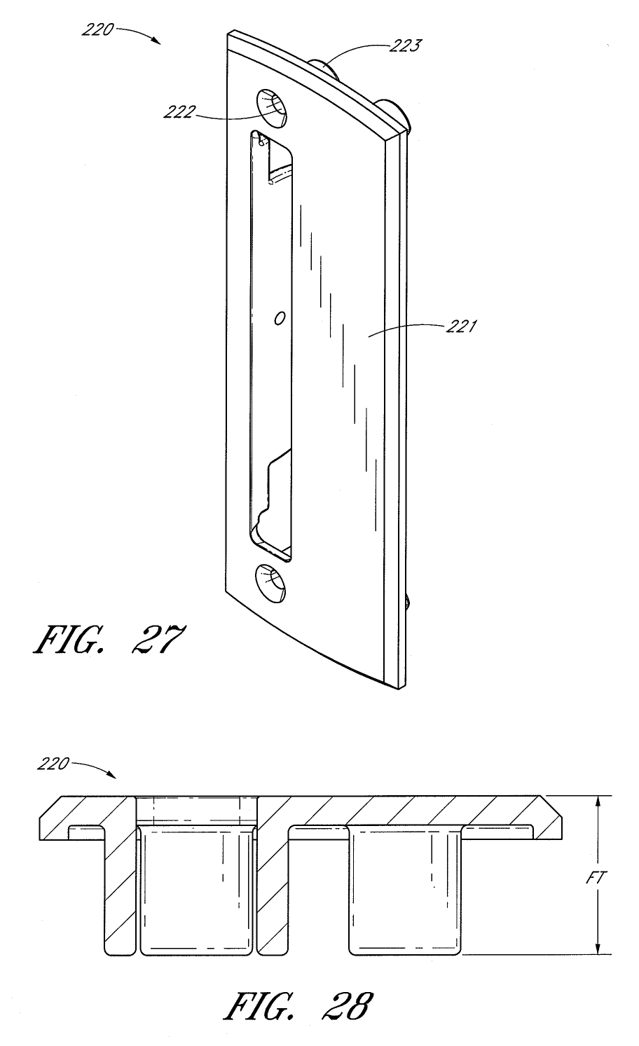

In one embodiment, a handle 210 comprises a gripping portion 212, a base portion 213, a recessed configuration surface 214, a rotation axis 215, a rotation interface 216. In one embodiment, handle 210 can comprise an optional finger grip 211. In one embodiment, handle 210 can comprise an optional rotation lock 217. FIGS. 20-23 illustrate various views of a handle 210 according to an embodiment of the present invention.

In one embodiment, the gripping portion 212 is configured for a comfortable grip accessible in the door system's 200 exposed configuration 260. In one embodiment, gripping portion 212 may be configured and/or shaped and/or weighted with a lighter or heavier portion in order to balance the handle 210 for rotation by moving the center of gravity of the handle with respect to the rotation interface 216 such that the handle 210 can “automatically” rotate with the assistance of gravity once it reaches an angle A between the handle 210 and faceplate 220 at rotation axis 215.

In one embodiment, base portion 213 positions the rotation interface 216 for rotation axis 215. In one embodiment, base portion 213 may be configured and/or shaped and/or weighted with a lighter or heavier portion in order to balance the handle 210 for rotation by moving the center of gravity of the handle with respect to the rotation interface 216 such that the handle 210 can “automatically” rotate with the assistance of gravity once it reaches an angle A between the handle 210 and faceplate 220 at rotation axis 215.

In one embodiment, the recessed configuration surface 214 is finished to appear similar to or blend in with the faceplate 220. In one embodiment, the recessed configuration surface 214 is finished to visually stand out with respect to the faceplate 220.

In one embodiment, rotation interface 216 is a hole through which a dowel or pin can act as a hinge for rotating the handle 210 with respect to the faceplate 220. In various embodiments, rotation interface 216 can comprise a bushing, bearings, washers, dry or wet lubricant, and/or other rotation interface structures. In one embodiment, the rotation interface 216 can comprise one or more gears, pulleys, chains, drive mechanisms, hydraulics, pneumatics, or other controllable means for actuating the handle 210.

In various embodiments, the optional rotation lock 217 is a temporary or permanent locking mechanism for holding the handle 210 in a recessed configuration 250 or an exposed configuration 260. In one embodiment, the rotation lock 217 is a ball and detent. In one embodiment, the rotation lock 217 is a hole and pin. In one embodiment, the rotation lock 217 is a cushion or locking surface.

In one embodiment, handle 210 comprises a height H, a width W and a thickness T. In various embodiments, the height H is in the range of approximately 2-8 inches, 3-6 inches, 4-5 inches. In one embodiment, the height H is within the range of 4.5-4.7 inches, and in one embodiment height H is 4.64 inches. In various embodiments, the width W is in the range of approximately 1-4 inches, 2-3 inches, 2.5-2.9 inches. In one embodiment, the width W is within the range of 2.7-2.8 inches, and in one embodiment width W is 2.73 inches. In various embodiments, the thickness T is in the range of approximately 0.25-3 inches, 0.3-1 inches, 0.4-0.6 inches, and in one embodiment thickness T is 0.5 inches.

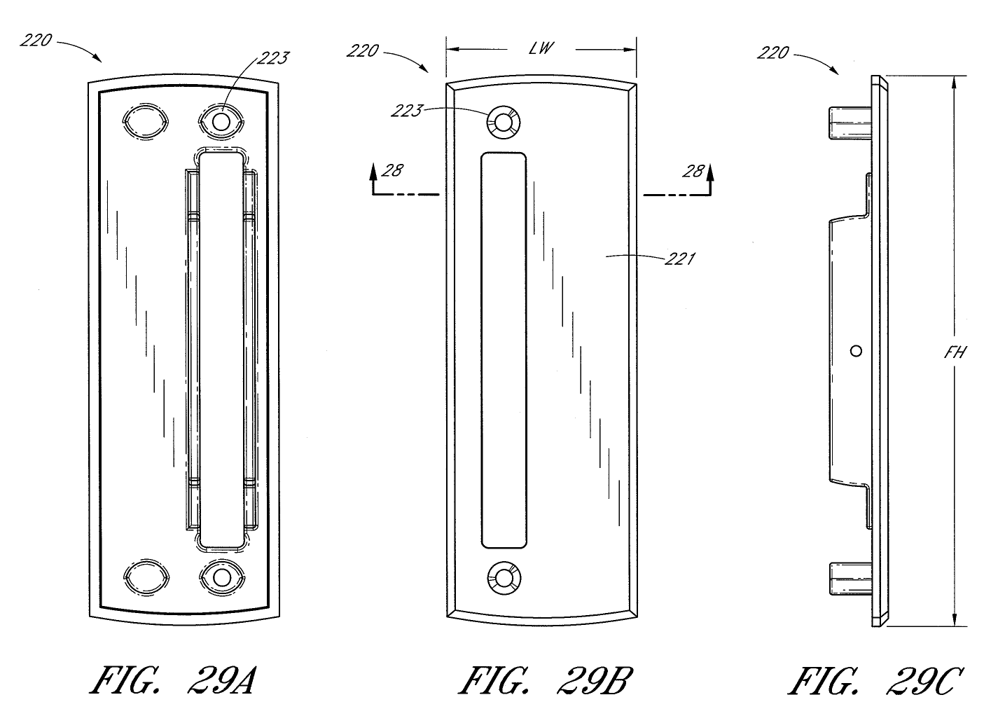

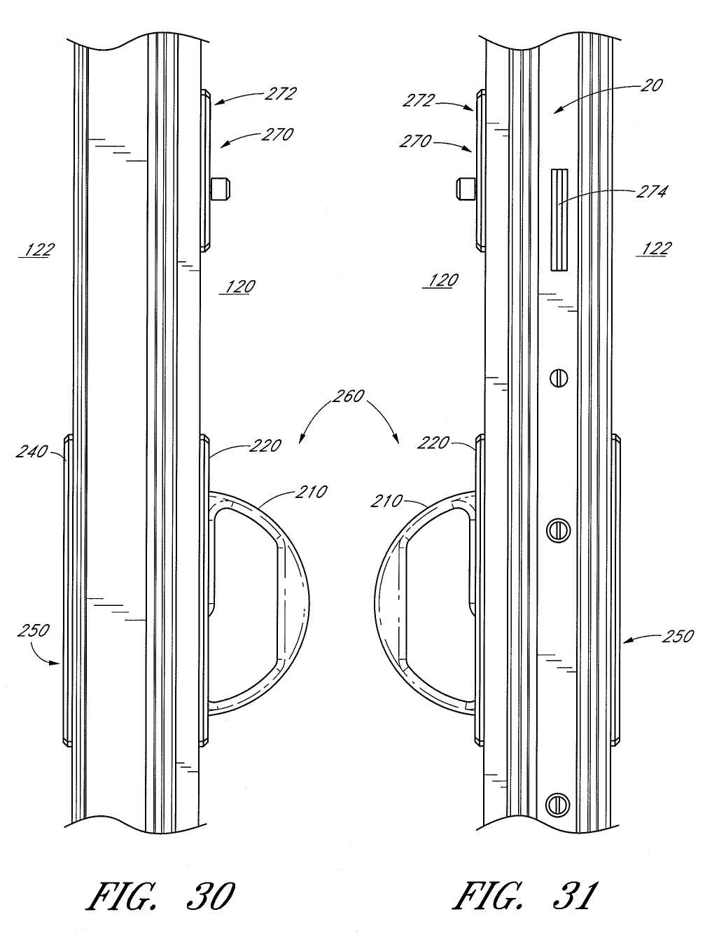

FIGS. 24-26C illustrate a faceplate 220 according to an embodiment of the present invention. In one embodiment, faceplate 220 comprises a visible surface 221, a mounting interface 223, at least one shoulder 224, a handle opening 225 and a handle interface 226. In one embodiment, the visible surface 221 is visible when the faceplate 220 is mounted to a door panel 10. In one embodiment, the mounting interface 223 is configured to attach to the door panel 10, or another faceplate 220′ with optional mounting hardware 222. In one embodiment, at least one shoulder 224 is configured to allow the handle 210 to support the actuation of sufficient loading to move one or several doors attached to the handle system 200 in a door system 11. In one embodiment, the shoulder 224 is configured to handle a lateral load for moving one, two, three, four, five or more slideably attachable sliding doors. In one embodiment, a handle opening 225 provides a space in which a handle 210 can be placed with a handle interface 226. In one embodiment, the handle opening 225 is configured for rotational positioning of the handle 210 with a rotational handle interface 226. In one embodiment, handle interface 226 works in conjunction with a rotation interface 216 on the handle 210. In various embodiments, the faceplate 220 can be various dimensions. In one embodiment the faceplate width FW is approximately 2 inches. In one embodiment the faceplate height FH is approximately 6 inches. In one embodiment the faceplate thickness FT (as shown in FIG. 28) is approximately 0.7 inches. In several embodiments, the door handles described herein are configured to withstand loads (e.g., lateral loads) of about 50-100 lbs, 100-200 lbs, 200-300 lbs, 300-400 lbs, 400-500 lbs, 500-750 lbs, 750-1000 lbs, 1000-1500 lbs, 1500-2000 lbs, 2000-2500 lbs, 2500-3000 lbs, 3000-4000 lbs, 5000-10000 lbs, or greater, and overlapping ranges thereof. In some embodiments, the door handles described herein are configured for multiple door panels, including a series of 1, 2, 3, 4, 5, 6, 7, 8, or more connected or coupled panels having individual weights of about 50-100 lbs, 100-200 lbs, 200-300 lbs, 300-400 lbs, 400-500 lbs, 500-750 lbs, 750-1000 lbs, and 1000-1500 lbs, or greater, and overlapping ranges thereof.

In one embodiment, the faceplate 220 can have the handle opening 225 offset to a side in order to accommodate a second handle 230 which may operate on the other side of the door panel 10.

FIGS. 27-29C illustrate a faceplate 220 according to an embodiment of the present invention with mounting hardware 222 visible on the visible surface 221. In one embodiment, this faceplate 220 is used on an interior 120 side of a door panel 10. In one embodiment, this faceplate 220 is used on an exterior 122 side of a door panel 10.

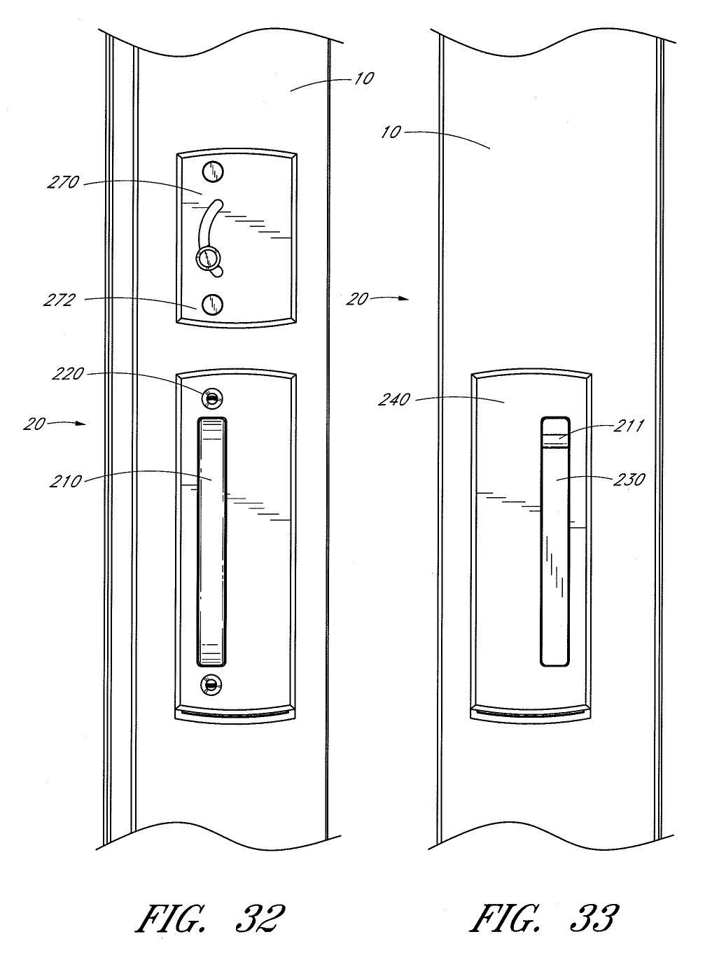

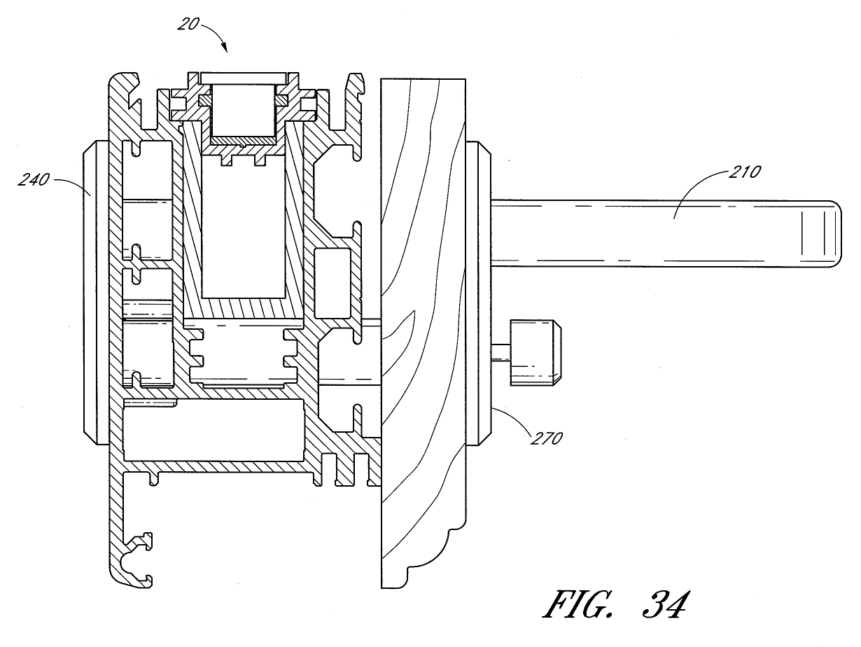

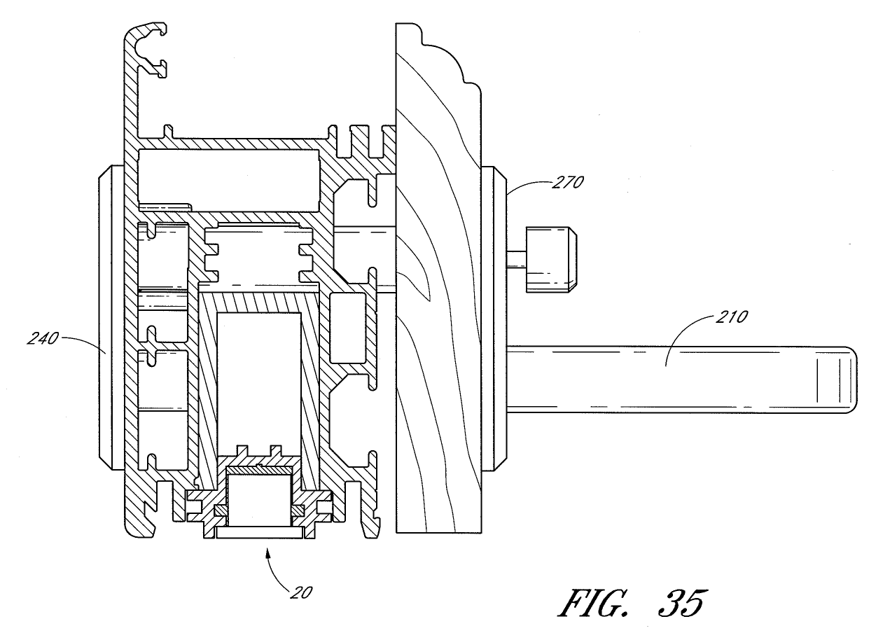

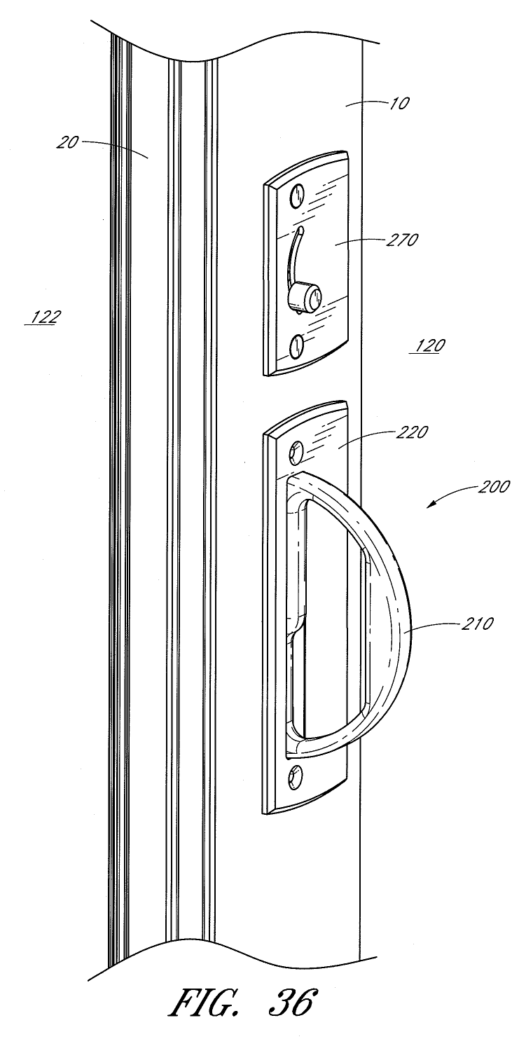

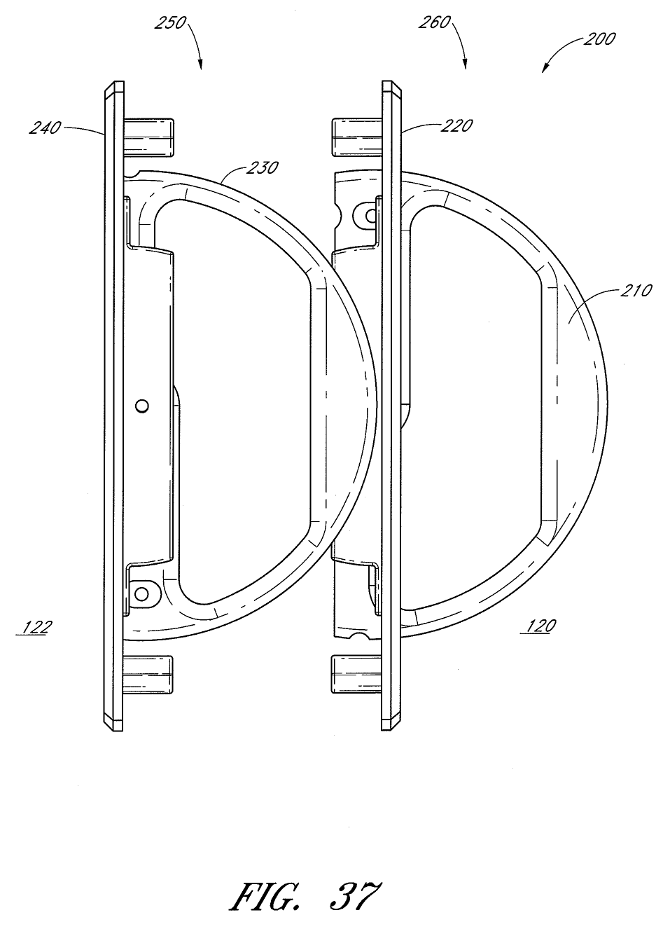

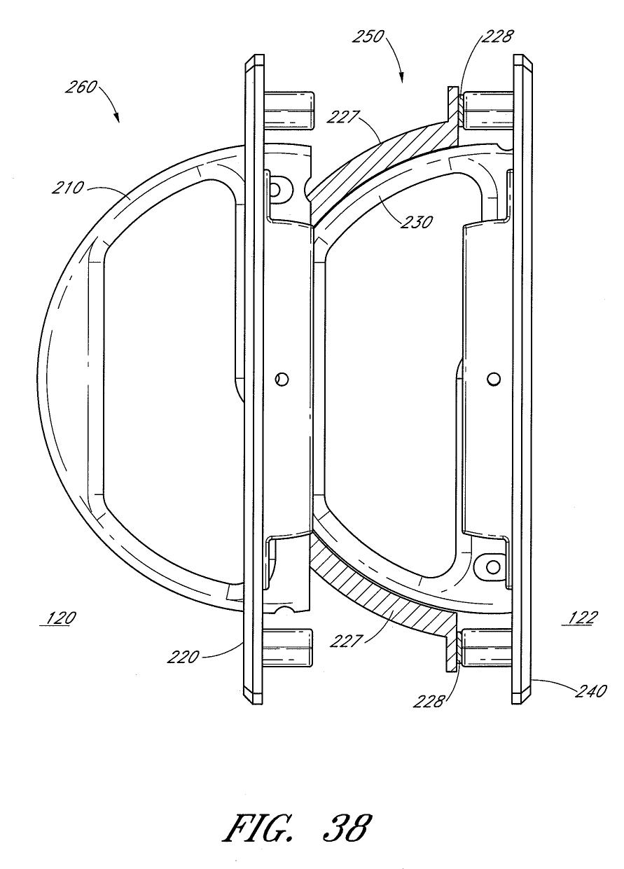

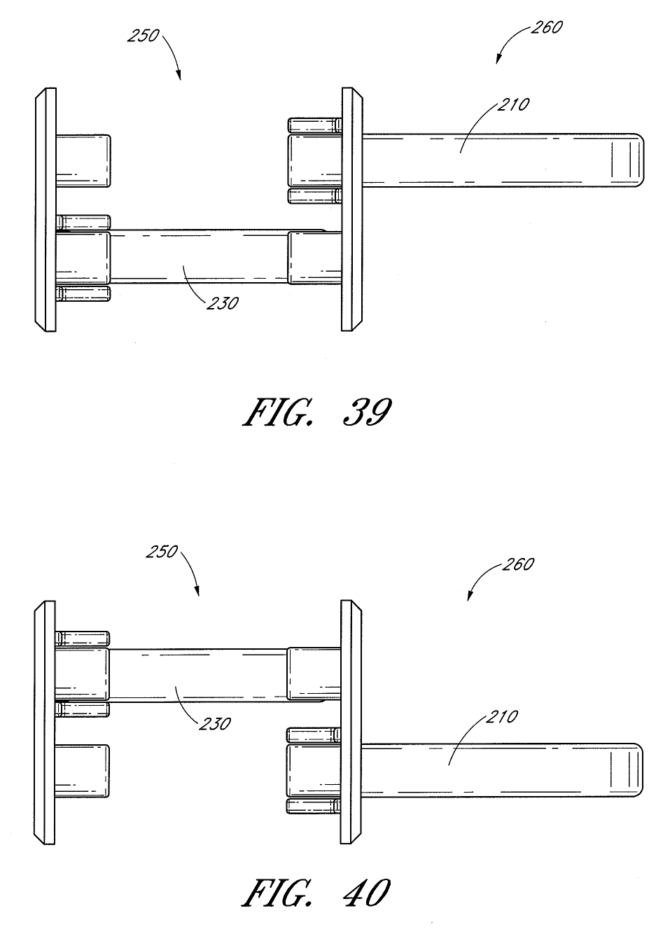

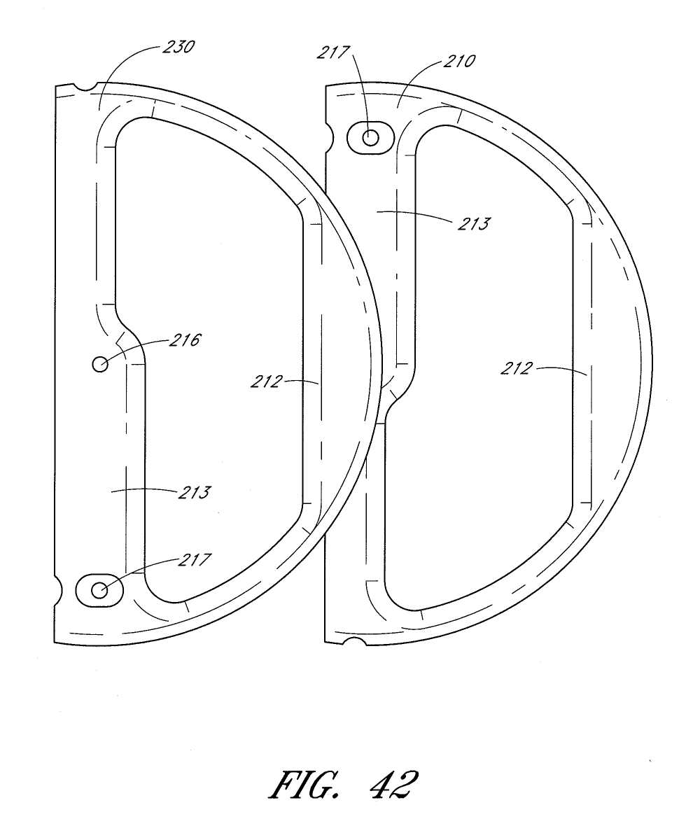

In one embodiment, a door handle system 200 comprises a first handle 210 and a second handle 230. FIGS. 30-43 illustrate various views and cut away or transparent views of a door handle system 200 with one handle 210 in an exposed configuration 260 and a second handle 230 in a recessed configuration 250 according to an embodiment of the present invention.

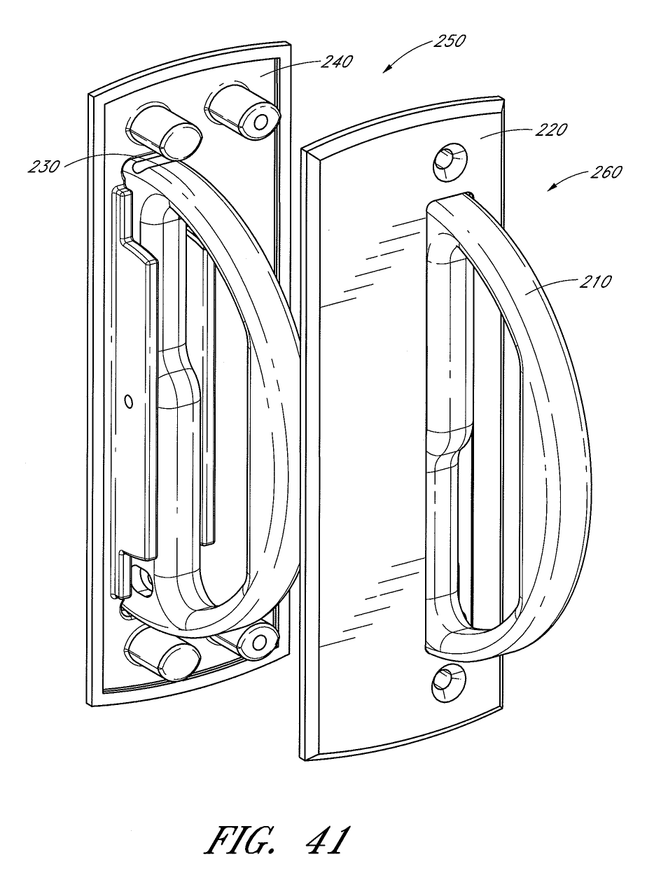

FIGS. 37-43 illustrate the door handle system 200 of FIG. 30 with the door panel 10 removed or transparent. FIG. 38 illustrates an optional embodiment of the door handle system 200 further comprising a pocket 227. In various embodiments, a pocket 227 can be added to one, both, or more faceplates 220, 240 on the interior of the handle opening 225 to house the handle 210, 230. In one embodiment, the pocket 227 can close off air or water or any elements that may pass between the handle 210,230 and the faceplate 220, 240 to prevent air or water or elements from entering or exiting the door panel 10 via the handle system 220 between the interior 120 and the exterior 122. In one embodiment, the pocket 227 can be attached with seal, flange, and/or gasket 228. In FIG. 38 only one pocket 227 is shown attached to the faceplate 230 corresponding to the exterior 122, where more air or water may be present. However in various embodiments another pocket 227 can be included for the other handle 210 on the interior 120.

FIGS. 42-43 illustrates the door handle system 200 of FIG. 30 with the door panel 10 and both faceplates 220, 240 removed or transparent.

In some embodiments, a method of operating a sliding door includes rotating a first rotatable handle from a recessed configuration to an exposed configuration, the first rotatable handle rotatably engaged to a first sliding door panel, the door panel comprising an interior side, an exterior side and a sliding movement direction and applying a lateral force to the first rotatable handle in the exposed configuration to move the first sliding door along the sliding movement direction. In one embodiment, an axis of rotation of the rotatable handle is parallel to the movement direction of the sliding door. In one embodiment, the method also includes rotating a second rotatable handle from a recessed configuration to an exposed configuration, the second rotatable handle rotatably engaged to the first sliding door panel on a side opposite the first rotatable handle, and applying a lateral force to the second rotatable handle in the exposed configuration to move the first sliding door along the sliding movement direction.

In one embodiment, the method also includes rotating a second rotatable handle from a recessed configuration to an exposed configuration, the second rotatable handle rotatably engaged to a second sliding door panel, the second sliding door panel comprising an interior side, an exterior side and a sliding movement direction parallel to the sliding movement direction of the first sliding door panel and applying a lateral force to the second rotatable handle in the exposed configuration to move the second sliding door along the sliding movement direction.

It will be understood by those of skill in the art that numerous and various modifications can be made without departing from the spirit of the present invention. Therefore, it should be clearly understood that the forms of the present invention are illustrative only and are not intended to limit the scope of the present invention. Although a few embodiments have been described in detail above, other modifications are possible. Other embodiments may be within the scope of the following claims. It will be understood that the foregoing is only illustrative of the principles of the invention, and that various modifications, alterations, and combinations can be made by those skilled in the art without departing from the scope and spirit of the invention. Accordingly, it is not intended that the invention be limited, except as by the appended claims.

1. A recessable rotary door handle system configured for lateral movement of one or more sliding doors, comprising:
a first rotatable handle rotatably engaged to a first faceplate; and a second rotatable handle rotatably engaged to a second faceplate;
wherein the first faceplate is configured for engagement with the second faceplate through a door panel, the door panel comprising an interior side, an exterior side and an edge between the exterior side and the interior side;
wherein the first faceplate is configured to be disposed on the interior side of the door panel;
wherein the second faceplate is configured to be disposed on the exterior side of the door panel;
wherein the first handle is rotatably actuatable between a recessed configuration and an exposed configuration;
wherein the second handle is rotatably actuatable between the recessed configuration and the exposed configuration.

2. The recessable rotary door handle system of claim 1, further comprising a first door panel.

3. The recessable rotary door handle system of claim 2, further comprising a second door panel, wherein at least one of the first rotatable handle and the second rotatable handle is configured to slide the first door panel in the exposed configuration and is configured for sliding the first door panel along the second door panel when the at least one of the first rotatable handle and the second rotatable handle is in the recessed configuration.

4. The recessable rotary door handle system of claim 2, the door panel further comprising a lock system.

5. The recessable rotary door handle system of claim 4, the lock system comprising a lock hook.

6. The recessable rotary door handle system of claim 1, wherein the first rotatable handle is weighted to allow it to maintain the exposed configuration when swiveled about its axis by an angle with respect to the first face plate in a first direction.

7. The recessable rotary door handle system of claim 1, wherein the first rotatable handle is weighted to allow it to maintain the recessed configuration when swiveled about its axis by an angle with respect to the first face plate in a second direction.

8. The recessable rotary door handle system of claim 1, wherein the first rotatable handle is configured to support a lateral force to open or close one or more door panels.

9. The recessable rotary door handle system of claim 8, wherein the first rotatable handle is configured to support a lateral force of at least 1,000 pounds to open or close one or more door panels.

10. The recessable rotary door handle system of claim 8, wherein the first rotatable handle is configured to support a lateral force of at least 100 pounds to open or close one or more door panels.

11. The recessable rotary door handle system of claim 1, wherein the first rotatable handle comprises a finger grip for actuating the first rotatable handle between the recessed configuration to the exposed configuration.

12. A recessable rotary door handle system configured for lateral movement of a sliding door, comprising:
a rotatable handle rotatably engaged to a faceplate;
wherein the faceplate is configured for engagement with at least one of an interior side and an exterior side of a sliding door panel;
wherein the handle is rotatably actuatable between a recessed configuration and an exposed configuration;
wherein an axis of rotation of the rotatable handle is parallel to a movement direction of the sliding door panel.

13. The recessable rotary door handle system of claim 12, wherein the faceplate is configured to be disposed on the interior side of the door panel.

14. The recessable rotary door handle system of claim 12, wherein the second faceplate is configured to be disposed on the exterior side of the door panel.

15. The recessable rotary door handle system of claim 12, the door panel further comprising a lock system.

16. A method of operating a sliding door, comprising:
rotating a first rotatable handle from a recessed configuration to an exposed configuration, the first rotatable handle rotatably engaged to a first sliding door panel, the door panel comprising an interior side, an exterior side and a sliding movement direction;
wherein an axis of rotation of the rotatable handle is parallel to the movement direction of the sliding door; and
applying a lateral force to the first rotatable handle in the exposed configuration to move the first sliding door along the sliding movement direction.

17. The method of operating a sliding door according to claim 16, wherein the extended configuration of the rotatable handle is configured to extend outwardly from the interior side of the sliding door.

18. The method of operating a sliding door according to claim 16, further comprising:
rotating a second rotatable handle from a recessed configuration to an exposed configuration, the second rotatable handle rotatably engaged to the first sliding door panel on a side opposite the first rotatable handle; and
applying a lateral force to the second rotatable handle in the exposed configuration to move the first sliding door along the sliding movement direction.

19. The method of operating a sliding door according to claim 16, further comprising:
rotating a second rotatable handle from a recessed configuration to an exposed configuration, the second rotatable handle rotatably engaged to a second sliding door panel, the second sliding door panel comprising an interior side, an exterior side and a sliding movement direction parallel to the sliding movement direction of the first sliding door panel; and
applying a lateral force to the second rotatable handle in the exposed configuration to move the second sliding door along the sliding movement direction.
